(19) United States
(12) Patent Application Publication
(10) Pub. No.: US 2013/0202448 A1
(43) Pub. Date: Aug. 8, 2013

(54) ROTOR HUB FOR A WIND TURBINE

(71) Applicant: Christian Laursen, Hedensted (DK)

(72) Inventor: Christian Laursen, Hedensted (DK)

(21) Appl. No.: 13/752,745

(22) Filed: Jan. 29, 2013

(30) Foreign Application Priority Data
Feb. 2, 2012 (EP) 12153679.1

(51) Int. Cl. F03D 1/06

(52) U.S. Cl. CPC F03D 1/0691
USPC 416/244 R

(57) ABSTRACT

A rotor hub for a wind turbine is provided. The rotor hub is adapted to support at least one rotor blade. The rotor hub has a base body. The base body has a first section providing a connecting site connectable with a wind turbine structure and an opposing second section providing a freely exposed front portion. The front portion is at least partially built of a sandwich-construction.

### CROSS REFERENCE TO RELATED APPLICATIONS

This application claims priority of European Patent Office application No. 12153679.1 EP filed Feb. 2, 2012, which is incorporated by reference herein in its entirety.

### FIELD OF INVENTION

The application relates to a rotor hub for a wind turbine, adapted to support or supporting at least one rotor blade, with the rotor hub comprising a base body having a first section providing a connecting site connectable with a wind turbine structure and an opposing second section providing a freely exposed front portion.

### BACKGROUND OF INVENTION

Rotor hubs for wind turbines or so called spinners are essential components of a wind turbine and are usually rotatably supported relative to the nacelle of a wind turbine.

With the dimensions of modern wind turbines having steadily increased in the last decades, the dimensions of respective rotor hubs have increased as well, whereby respective large-dimensioned rotor hubs have high weight and may be problematic in regard of handling. Aside, respective large-dimensioned rotor hubs are usually cast parts which is problematic since appropriate constructive designs, i.e. geometrically shapes, are often limited which may result in constructive designs which may not be ideal in regard of structural loads to be carried by the rotor hub during operation of the wind turbine.

### SUMMARY OF INVENTION

It is the object of the application to provide an improved rotor hub for a wind turbine.

The object is achieved by a rotor hub as initially described, characterised in that the front portion is at least partially built of a sandwich-construction.

The disclosed principle suggests a rotor hub, comprising a sandwich-construction provided with the front portion of its base body. Thereby, front portion refers to the axially freely exposed portion of a respective second section of the base body of the rotor hub, i.e. a respective section being oppositely disposed relative to a respective first section having a connecting site connectable with a wind turbine structure, i.e. for connecting the rotor hub with a wind turbine structure or respective wind turbine structure elements such as a nacelle of a wind turbine and/or a respective shaft of a wind turbine. The front portion may have a disc- or ring-like shape for instance.

According to the disclosed principle, the front portion of the base body of the rotor hub, which may be a single-part component or a multi-part component, is at least partially provided with a respective sandwich-construction providing the front portion and the entire rotor hub with additional mechanical stability, i.e. mechanical stiffness. Additionally, sandwich-constructions are comparatively light-weight structures reducing the total weight of the rotor hub which is of feature in regard of handling of the rotor hub.

The sandwich-construction may comprise at least two opposing stiffening layers and at least one intermediate layer disposed in between the stiffening layers. The stiffening layers, which covers the top or bottom surface of the intermediate layer, are usually comparatively thin compared with the intermediate layer. In comparison to the intermediate layer, the stiffening layers are provided with high bending stiffness. In such a manner, a respective sandwich-construction is a component or element having a high bending stiffness and comparatively low weight. The stiffening layers may also be denoted as skin layers, whereas the intermediate layer(s) may also be denoted as core layers.

It is possible that the stiffening layers are made of metal, such as iron-based metal, and/or composite material, such as fibre-reinforced plastic material. Metals generally embrace all kinds of metals or sheet metals having good mechanical properties, i.e. high bending stiffness. Iron-based metals, such as steel, are used for providing respective stiffening elements. Yet, other metals or metal alloys apart from iron-based metals, such as titanium for instance, may be used as well. Composite materials generally also comprise good mechanical properties and embrace all kinds of fibre materials, i.e. glass fibres and/or carbon fibres and/or inorganic fibres distributed in plastic or resin-like materials representing a matrix material. Composite materials also embrace all kinds of laminate structures of fibres reinforcing plastic or resin-like materials.

The intermediate layer may be made of plastic or composite material, such as fibre-reinforced reinforced plastic material. All aforementioned annotations regarding respective composite materials apply here. Hence, the intermediate layer may be provided with a respective structural stiffness in dependency of the respective applied composite material.

In order to reduce weight of the sandwich-structure, the intermediate layer may comprise an intermediate layer body having a comb-like and/or cellular structure. Comb-like or cellular structures such as open or closed cellular foam structures made of plastics, metals, or ceramics for instance provide both high specific stiffness and low weight and are used for building a respective intermediate layer.

The stability of the sandwich-construction may be enhanced, when the intermediate layer is attached to the stiffening layers. Thereby, attaching the intermediate layer to the respective stiffening layers generally embraces all kinds of attachment types assuring a mechanically firm and stable connection between the intermediate layer and the respective stiffening layers.

Attachment of the intermediate layer(s) is provided by at least one bonding agent, such as an adhesive means, and/or by welding and/or brazing. In either case, non-detachable and hence, mechanically stable connections of the intermediate layer(s) and the stiffening layers are feasible.

Regarding the connection of the front portion and the remainder of the base body of the rotor hub it is possible that the front portion is attached to at least one flange-like portion provided with the base body. In such a manner, the base body may comprise an aperture having, such as radially extending and possibly integrally built, flange-like portions to which the sandwich-construction building the front portion of the rotor hub is securely attached, i.e. bolted, welded or the like. Flange-like portions are attached to the stiffening layers of the sandwich-construction.

Aside, the application refers to a wind turbine, such as a direct drive wind turbine, comprising at least one rotor hub as specified above.

### BRIEF DESCRIPTION OF THE DRAWINGS

In the following, the application is described in detail as reference is made to the principle drawings, whereby:

FIG. 1 a perspective view of a rotor hub according to an embodiment of the application;

FIG. 2 a perspective cut-view of the rotor hub according to FIG. 1;

FIG. 3 a vertically cut-view of a rotor hub according to a further embodiment of the application;

FIG. 4 a first view of the detail of FIG. 3; and

FIG. 5 a second view of the detail of FIG. 3.

### DETAILED DESCRIPTION OF INVENTION

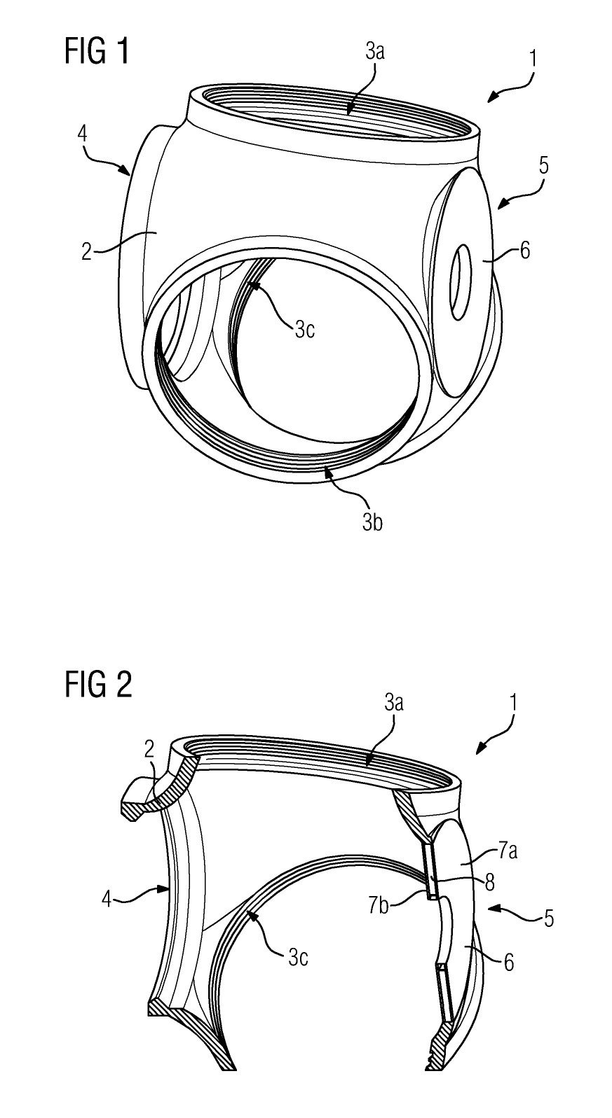

FIG. 1 shows a perspective view of a rotor hub 1 according to an embodiment of the application. In known manner, the rotor hub 1 is adapted to support a number of rotor blades (not shown) of a wind turbine (not shown). The base body 2 of the rotor hub 1 is provided with respective connecting sites 3a, 3b, 3c for supporting respective rotor blades. The connection sites 3a, 3b, 3c may serve as bearing (outer) rings of respective rotor blade bearings (not shown).

The rotor hub 1 may be attached to a wind turbine (not shown) in known manner. The base body 2 of the rotor hub 1 comprises a first section 4 providing a connecting site connectable with a wind turbine structure such as a wind turbine nacelle or the like. A second section 5 in opposite disposal relative to the first section 4 provides a freely exposed ring-like shaped front portion 6.

As is discernible from FIG. 2 showing a perspective cut-view of the rotor hub 1 according to FIG. 1, the front portion 6 is built of a sandwich-construction. The sandwich-construction comprises two opposing ring-like shaped stiffening layers 7a, 7b and an intermediate layer 8 disposed in between the stiffening layers 7a, 7b, i.e. in the annular space or cavity provided between the stiffening layers 7a, 7b. In exceptional cases, the annular space between the stiffening layers 7a, 7b may be left empty, i.e. a respective intermediate layer 8 is not obligatorily provided.

The stiffening layers 7a, 7b are made of metal, such as iron-based metal, i.e. steel. Hence, the stiffening layers 7a, 7a are provided as plain steel plates. In alternative embodiments, the stiffening layers could also be made of composite material, such as fibre-reinforced plastic material.

The intermediate layer 8 is made of plastic or composite material, such as fibre-reinforced plastic material. The intermediate layer 8 comprises an intermediate layer body having a comb-like structure. The intermediate layer body could also be made of a cellular or foamed plastic or composite material. The intermediate layer 8 is firmly attached to the stiffening layers 7a, 7b by adhering, welding, or brazing for instance.

The remainder of the base body 2 of the rotor hub 1, i.e. all parts of the base body 2 apart from the front portion 6 may be built as a cast (metal) part as is known from prior art.

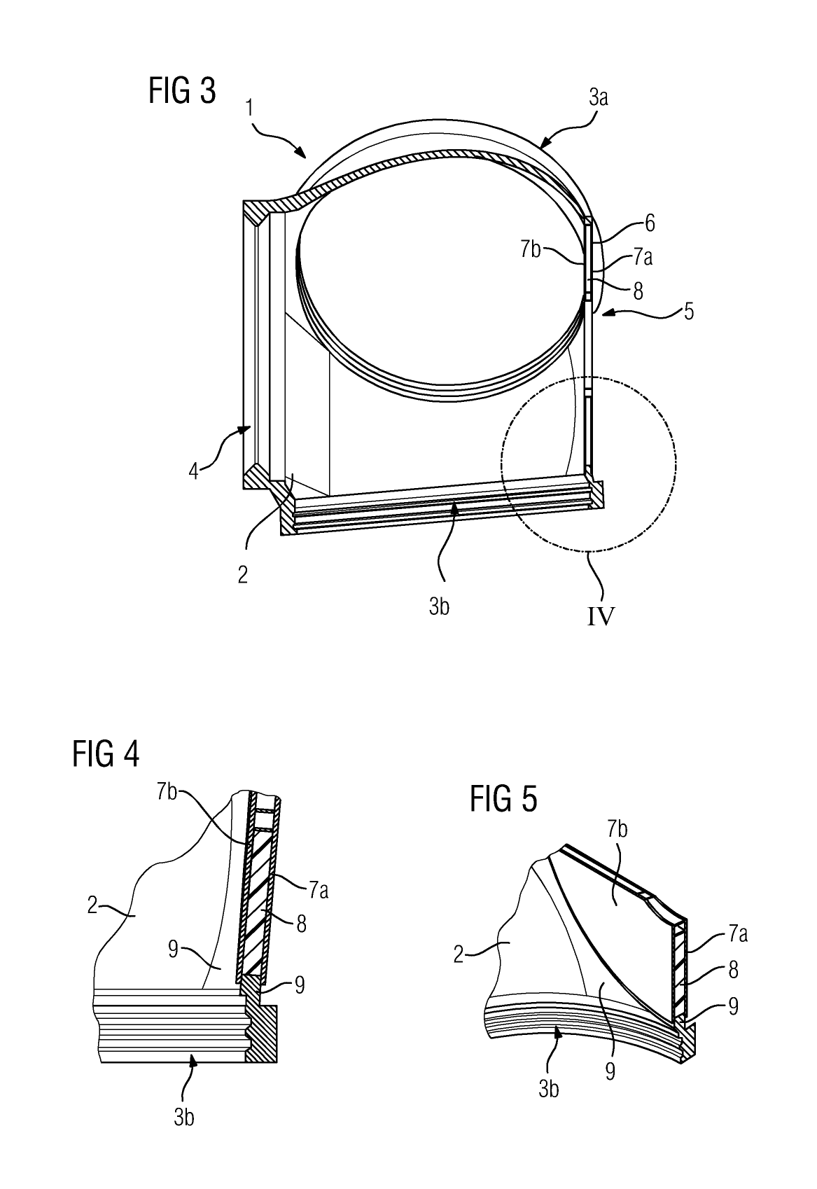

As is discernible from the FIG. 3-5, whereby FIG. 3 shows a vertically cut-view of a rotor hub 1 according to a further embodiment of the application and FIG. 4, 5 show respective first and second views of the detail of FIG. 3, the sandwich-construction building the front portion 6 is attached to the base body 2 of the rotor hub 1 by respective flange-like portions 9a, 9b extending off the base body 2 in radial (cf. flange-like portion 9a) and/or axial (cf. flange-like portion 9b) direction.

The front portion 6 is securely attached, i.e. bolted, welded or the like to the respective flange-like portions 9a, 9b of the base body 2 of the rotor hub 1. As is discernible from FIG. 4, 5, respective flange-like portions 9a may be attached to the stiffening layers 7a, 7b as well as the intermediate layer 8 of the sandwich-construction.

By providing the front portion 6 of the rotor hub 1 with a respective sandwich-construction, the front portion 6 as well as the entire rotor hub 1 is provided with high mechanical stability, i.e. high mechanical (bending) stiffness, while the weight of the front portion 6 and thus the entire rotor hub 1 may be reduced. Furthermore, it is possible to dispose mechanically stable structures in the direct line of action of the load being applied or introduced to the rotor blade bearings, which is a favourable condition for the rotor blade bearings since they may encounter smaller fatigue damage.

As mentioned above, the disclosed rotor hub 1 is ready to be connected with a wind turbine. The wind turbine may be a direct drive wind turbine, i.e. a wind turbine having a direct mechanical connection of a main shaft connected to the rotor hub 1 with a power generating unit such as a generator or a direct mechanical connection of the rotor hub 1 and a respective power generating unit such as a generator.

Although the present application has been described in detail with reference to the embodiment, the present application is not limited by the disclosed examples from which the skilled person is able to derive other variations without departing from the scope of the application.

1. A rotor hub of a wind turbine for supporting a rotor blade of the wind turbine, comprising:
a base body comprising:
a first section for providing a connecting site connectable with a wind turbine structure, and
a second section that is opposite to the first section for providing a freely exposed front portion,
wherein the front portion comprises a sandwich-construction.

2. The rotor hub according to claim 1, wherein the sandwich-construction comprises two opposing stiffening layers and an intermediate layer, wherein the intermediate layer is disposed in between the two opposing stiffening layers.

3. The rotor hub according to claim 2, wherein the two opposing stiffening layers are made of metal and/or composite material.

4. The rotor hub according to claim 2, wherein the two opposing stiffening layers are made of iron-based metal and/or fibre-reinforced plastic material.

5. The rotor hub according to claim 2, wherein the intermediate layer is made of plastic or composite material.

6. The rotor hub according to claim 2, wherein the intermediate layer is made of fibre-reinforced plastic material

7. The rotor hub according to claim 2, wherein the intermediate layer comprises an intermediate layer body having a comb-like and/or cellular structure.

8. The rotor hub according to claim 2, wherein the intermediate layer is attached to the two opposing stiffening layers.

9. The rotor hub according to claim 8, wherein the intermediate layer is attached to the two opposing stiffening layers by a bonding agent, by welding and/or by brazing.

10. The rotor hub according to claim 8, wherein the intermediate layer is adhesively attached to the two opposing stiffening layers.

11. The rotor hub according to claim 1, wherein the base body comprises a flange-like portion, and wherein the front portion is attached to the flange-like portion.

12. A wind turbine, comprising:
a rotor hub according to claim 1.

13. The wind turbine according to claim 12, wherein the wind turbine is a direct drive wind turbine.
